(19) United States
(12) Patent Application Publication
(10) Pub. No.: US 2007/0004471 A1
(43) Pub. Date: Jan. 4, 2007

(54) Electronic device including first and second parts and a flexible printed circuit board for electrically connecting the two

(75) Inventor: Shun-Ping Wang, Taipei (TW)

Correspondence Address: BRUCE H. TROXELL, SUITE 1404, 5205 LEESBURG PIKE, FALLS CHURCH, VA, 22041, US

(73) Assignee: Inventec Appliances Corp.

(21) Appl. No.: 11/168,340

(22) Filed: Jun. 29, 2005

(51) Int. Cl. H04M 1/00

(52) U.S. Cl. 455/575.1

(57) ABSTRACT

A flip phone includes first and second parts, and a coupler shaft pivotally coupling the first and second parts. A flexible printed circuit board is disposed on the coupler shaft, and includes an elongated main portion wrapped around the coupler shaft and left and right portion extending outwardly from opposite ends of the main portion for inserting into the first and second parts in order to establish electrical communication between the first and second parts.

### FIELD OF THE INVENTION

The present invention relates to an electronic device, more particularly to a flexible printed circuit board for use in the electron device.

### BACKGROUND OF THE INVENTION

Electronic devices (such as mobile phones) of lately are designed in compact size in order to facilitate carrying thereof. The more convenient for the user to carry the handheld mobile phone, the smaller the dimension should become. In order to eliminate the bulky size (such as stand alone type), some mobile phones are designed in foldable type (generally known as flip phone or flip cell phone).

Referring to FIGS. 1A and 1B, a conventional flip phone 10 generally includes a main body 12, a cover member 13, and a coupler shaft 14 interposed between for connecting pivotally the main body 12 and the cover member 13. A flexible printed circuit board 2 (also known a flexible connector) is usually disposed on or within the coupler shaft 14, and includes a straight main portion 4, and left and right portions 18 that extend outwardly and oppositely from two opposite ends of the main portion 4 and that are to be inserted in the main body 12 and the cover member 13 for electrically coupling the same. Of course, each of the left and right portions 18 has a distal end 6 that is stripped to expose the conducting terminals 6a for establishing electrical communication with the electronic components enclosed within the main body 12 and the cover member 13.

Since the electronic components within the main body 12 and the cover member 13 are increased day-by-day in order to provide multiple functions of the conventional flip phone, the main portion 4 should have lots of data transmission lines 4a. In order to increase the data transmission lines 4a within the main portion 4, the width thereof must also be increased, which, in turn, results in widening the width of the left and right portions 18, thereby widening the entire area of the flexible printed circuit board 2.

Constant use of the conventional flip phone 10 results in folding and unfolding actions of the left and right portions 18 with respect to the main portion 4 (due to relative movement between the main body 12 and the cover member 13). Since the flexible printed circuit board 2 is disposed within the limited space within the coupler shaft 14, frequent folding and unfolding actions of the left and right portions 18 relative to the main portion 4 cause twisting and tearing at the adjoining spaces interconnecting the left and right portions 18 with the main portion 4, and eventually leads to rupture of the flexible printed circuit board 2. Replacement of the flexible printed circuit board 2 may result in extra expense and is time consuming to the user of the conventional flip phone.

### SUMMARY OF THE INVENTION

The main object of the present invention is to provide a flexible printed circuit board for use in a flip phone. The flexible printed circuit board has a unique construction and is disposed within the coupler shaft of the flip phone in such a manner to prevent rupture of the flexible printed circuit board regardless of long-term use of the flip phone.

A flexible printed circuit board is provided according to the present invention for use in an electronic device. The electronic device includes a first part, a second part, and a coupler shaft coupling pivotally the first and second parts in such a manner that the first and second parts are disposed at two opposite sides of the coupler shaft. The flexible printed circuit board is disposed on the coupler shaft for electrically interconnecting the first and second parts. The flexible printed circuit board includes: a U-shaped base plate made from a flexible material, and including an elongated main portion having two opposite ends, and left and right portions extending integrally and respectively from the two opposite ends of the elongated main portion in parallel manner along the same direction transverse to an axis of the elongated main portion, each of the left and right portions having a distal end; a first electrical contact set disposed on the distal end of the left portion for coupling electrically to the first part, the first electrical contact set including a plurality of first electrical contacts; and a second electrical contact set disposed on the distal end of the right portion for coupling electrically to the second part, the second electrical contact set including a plurality of second electrical contacts. In use, the elongated main portion is adapted to be rolled up and the rolled assembly is adapted to be disposed on the coupler shaft in such a manner that the left and right portions extend respectively and outwardly from the opposite sides of the coupler shaft for inserting the first and second electrical contacts into the first and second parts, thereby establishing electrical communication between the first and second parts.

### BRIEF DESCRIPTION OF THE DRAWINGS

Other features and advantages of this invention will become more apparent in the following detailed description of the preferred embodiment of this invention, with reference to the accompanying drawings, in which:

FIG. 1A is a fragmentary view of a conventional mobile phone;

FIG. 1B is a planar view of a flexible printed circuit board employed in the conventional mobile phone;

FIG. 2A is a fragmentary planar view of the preferred embodiment of an electronic device of the present invention;

FIG. 2B is a planar view of a flexible printed circuit board employed in the preferred embodiment of the electronic device of the present invention; and

FIG. 3 is a sectional view, illustrating how the flexible flat of FIG. 2B interconnects the first and second parts of the electronic device according to the present invention.

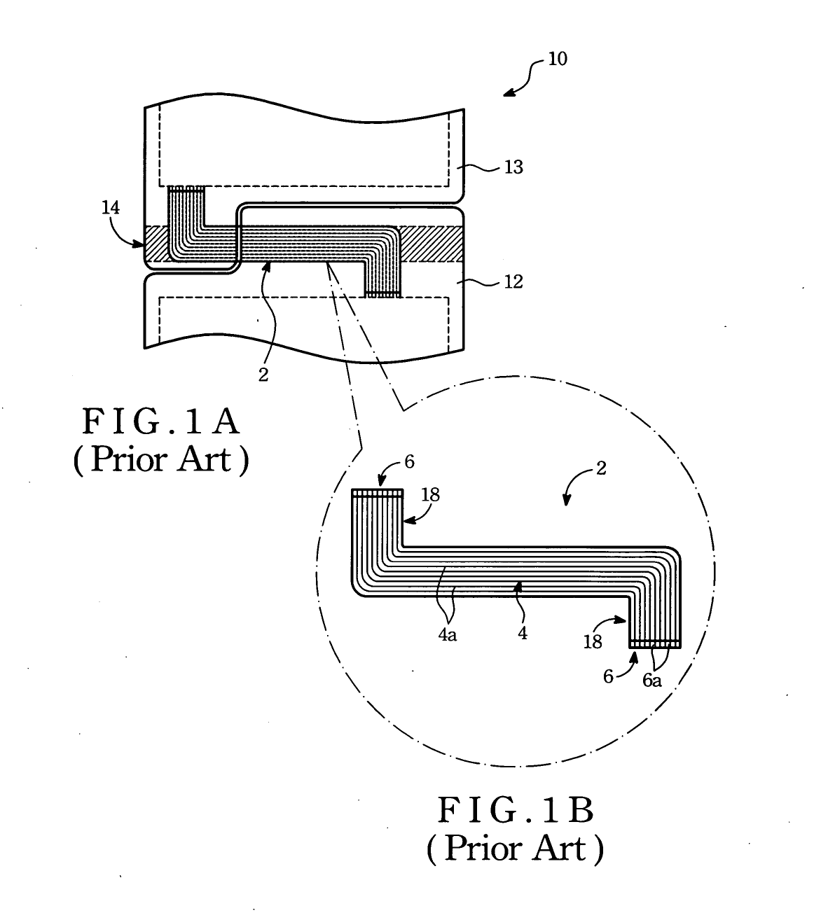

### DETAILED DESCCRIPTIONS OF THE PREFERRED EMBODIMENT

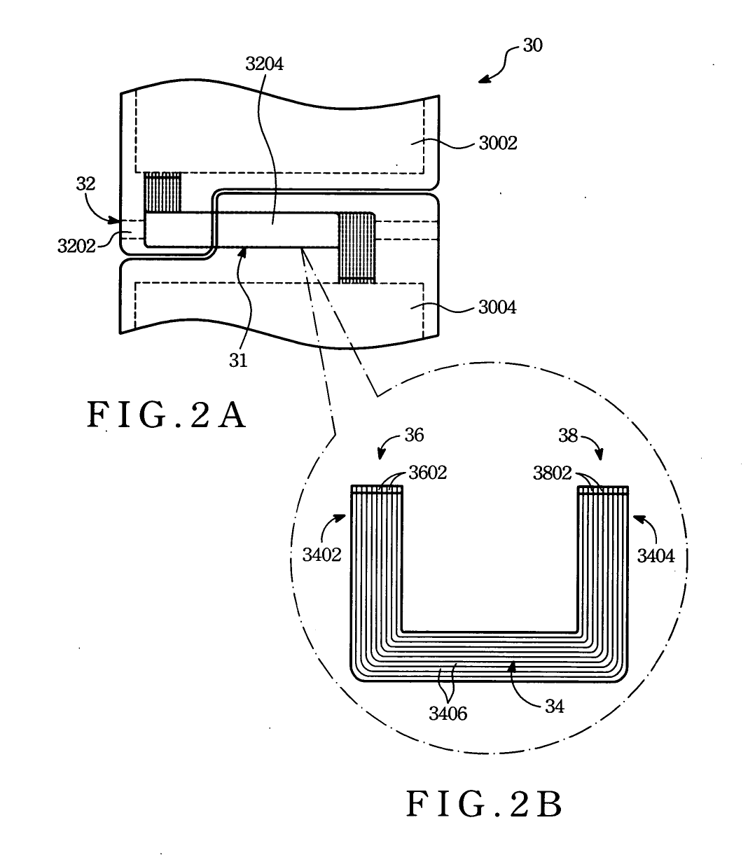

Referring to FIGS. 2A and 2B, the preferred embodiment of an electronic device 30 (such as a mobile phone or a flip phone) according to the present invention is shown to include a first part 3004, a second part 3002, a coupler shaft 32, and a flexible printed circuit board 34 (also known as flexible connector).

The coupler shaft 32 is disposed between the first part 3004 (hereinafter a main body) and the second part 3002 (hereinafter a cover member) for pivotally coupling the first and second parts 3002, 3004 in such a manner that the main body 3004 and the cover member 3002 are disposed at two opposite sides of the coupler shaft 32 (see FIG. 2A). The main body 3004 and the cover member 3002 are movable relative to each other about the coupler shaft 32. The structure of the coupler shaft 32 will be described in greater detail later.

The main body 3004 generally includes a keypad (not visible) for data inputting and an antenna assembly (not visible) for transmitting and receiving radio signals. The cover member 3002 is provided with a display screen (such as an LCD) for displaying input data or incoming signals.

The flexible printed circuit board 31 is disposed on the coupler shaft 32 for electrically interconnecting the electronic components within the main body 3004 and the cover member 3002. The flexible printed circuit board 31 includes a U-shaped base member 34, a first electrical contact set 36, and a second electrical contact set 38. The U-shaped base member 34 is made from a flexible material, and includes an elongated main portion 3406 having two opposite ends, and first and second portions 3402, 3404 extending integrally and respectively from the opposite ends of the elongated main portion 3406 in parallel manner along the same direction transverse to an axis of the elongated main portion 3406. Each of the first and second portions 3402, 3404 has a distal end. The first electrical contact set 36 has a plurality of first electrical contacts 3602 disposed on the distal end of the first portion 3402 for coupling electrically to the electronic components enclosed within the cover member 3002. The second electrical contact set 38 includes a plurality of second electrical contacts 3802 disposed on the distal end of the second portion 3404 for coupling electrically to the electronic components of the main body 3004. In practice, the distal ends of the first and second portions 3402, 3404 are stripped to expose the strands of data transmission lines for serving as the electrical contacts 3602, 3802. Alternately, a connector of predetermined configuration is mounted at the distal end of each of the first and second portions 3402, 3404. Under such a condition, the respective connector (not shown) can be directly inserted into the main body 3004 or the cover member 3002 for establishing electrical communication between the electronic components.

In use, the elongated main portion 3406 is first rolled up and the rolled assembly is disposed on the coupler shaft 32 in such a manner that the first and second portions 3402, 3404 extend respectively and outwardly from the opposite sides of the coupler shaft 32 for inserting the main body 3004 and the cover member 3002, thereby establishing electrical communication between the main body 3004 and the cover member 3002.

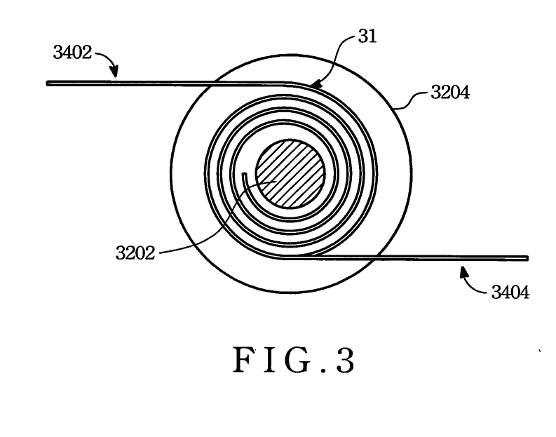

Referring to FIG. 3, the coupler shaft 32 of the preferred embodiment preferably includes a solid core 3202 and a hollow cylinder 3204. The solid core 3202 has one end integrally formed with the cover member 3002. The cylinder 3204 is integrally formed with the main body 3204. The other end of the solid core 3202 extends into the cylinder 3204. The elongated main portion 3406 of the flexible printed circuit board 34 is wrapped around the solid core 3202 while the first and second portions 3402, 3404 respectively and outwardly extend from the opposite sides of the cylinder 3204 for electrical coupling the main body 3204 and the cover member 3202.

Note that the width for accommodating the data transmission lines in the elongated main portion 3406 can be increased to correspond with the numbers of the electrical contacts 3602, 3802 of each of the first and second electrical contact sets 36, 38. Increase in the width of the elongated main portion 3406 is not restricted since the latter is wrapped around the solid core 3202. The data transmission between the main body 3204 and the cover member 3202 is not affect or hinder, since folding and unfolding actions of the cover member 3202 relative to the main body 3204 will not cause twisting and tearing of the first and second portions 3402, 3404 with respect to the elongated main portion 3406, thereby prolonging the service life of the mobile phone of the present invention.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A flexible printed circuit board (FPCB) in an electronic device, the electronic device including a first part, a second part and a coupler shaft coupling pivotally the first and second parts in such a manner that the first and second parts are disposed at two opposite sides of the coupler shaft, the flexible printed circuit board being disposed on the coupler shaft for electrically interconnecting the first and second parts, the flexible printed circuit board comprising:
a flexible printed circuit member including a main portion, a first portion, and a second portion, the first and second portions extending integrally and respectively from two opposite ends of the main portion in one direction;
a first electrical contact set including a plurality of first electrical contacts disposed on a distal end of the first portion for coupling electrically to the first part; and
a second electrical contact set including a plurality of second electrical contacts disposed on a distal end of the second portion for coupling electrically to the second part;
wherein, in use the main portion is adapted to be rolled up to cover the coupler shaft in such a manner that the first and second portions extend respectively in opposite directions for respectively inserting the first and second electrical contacts into the first and second parts for electrical communication between the first and second parts.

2. The flexible printed circuit board according to claim 1, wherein the electronic device is a mobile phone.

3. The flexible printed circuit board according to claim 1, wherein the first part has a keypad for data inputting operation.

4. The flexible printed circuit board according to claim 1, wherein the second part has a display screen.

5. The flexible printed circuit board according to claim 1, wherein each of the first and second portions is rotatable about said main portion.

6. The flexible printed circuit board according to claim 1, wherein the coupler shaft includes a solid core and a cylinder enclosing the solid core therein, the main portion being wrapped around the solid core while the first and second portions extend respectively and outwardly from opposite sides of the cylinder for electrical coupling to the first and second parts.
